(19) United States
(12) Patent Application Publication
(10) Pub. No.: US 2021/0201353 A1
(43) Pub. Date: Jul. 1, 2021

(54) INFORMATION PROCESSING DEVICE, INFORMATION PROCESSING SYSTEM, PROGRAM, AND INFORMATION PROCESSING METHOD

(71) Applicant: TOYOTA JIDOSHA KABUSHIKI KAISHA, Toyota-shi (JP)

(72) Inventors: Takuji YAMADA, Musashino-shi (JP); Jun TSUKAMOTO, Seto-shi (JP); Kaori SAKAI, Miyoshi-shi (JP)

(73) Assignee: TOYOTA JIDOSHA KABUSHIKI KAISHA, Toyota-shi (JP)

(21) Appl. No.: 17/109,659

(22) Filed: Dec. 2, 2020

(30) Foreign Application Priority Data
Dec. 25, 2019 (JP) 2019-234971

(51) Int. Cl. G06Q 30/02

(52) U.S. Cl. CPC G06Q 30/0265

(57) ABSTRACT

An information processing device includes a communication unit and a control unit. The communication unit performs information communication with a terminal device. When receiving route information, the control unit controls the communication unit to transmit to the terminal device an advertisement including an arrival point in a distribution area, and including expected arrival time in a target time slot or in a time slot preliminary time before the beginning of the target time slot. The route information is used to acquire the arrival point on the scheduled travel route to the destination and the expected arrival time at the arrival point.

### CROSS-REFERENCE TO RELATED APPLICATIONS

This application claims priority to Japanese Patent Application No. 2019-234971 filed on Dec. 25, 2019, incorporated herein by reference in its entirety.

### BACKGROUND

### 1. Technical Field

The present disclosure relates to an information processing device, an information processing system, a program, and an information processing method.

### 2. Description of Related Art

It has been examined to provide an advertisement to occupants in mobile objects such as vehicles. For example, it has been proposed to switch methods of providing an advertisement based on the degree of composure of a driver, the degree of composure being calculated based on at least one of the state of the driver and a surrounding condition (see Japanese Patent No. 6027280).

### SUMMARY

However, information to be provided is not necessarily useful for users and may possibly annoy the users. There is also room for improving advertisement effects.

An object of the present disclosure made in view of these circumstances is to provide an information processing device, an information processing system, a program, and an information processing method configured to provide an advertisement that is useful for a user or users in a mobile object.

An information processing device according to one embodiment of the present disclosure includes: a communication unit and a control unit. The communication unit is configured to perform information communication with a terminal device used in a mobile object. The control unit is configured to control the communication unit, when receiving route information that is used to acquire an arrival point of the mobile object on a scheduled travel route to a destination and an expected arrival time at the arrival point, such that the communication unit transmits an advertisement to the terminal device, the advertisement including the arrival point based on the route information in a distribution area and including the expected arrival time at the arrival point in a target time slot of an advertising content or in a time slot preliminary time before a beginning of the target time slot.

An information processing system according to one embodiment of the present disclosure includes: an information processing device; and a terminal device. The information processing device includes: a communication unit and a control unit. The communication unit is configured to perform information communication with the terminal device used in a mobile object. The control unit is configured to control the communication unit, when receiving route information that is used to acquire an arrival point of the mobile object on a scheduled travel route to a destination and an expected arrival time at the arrival point, such that the communication unit transmits an advertisement to the terminal device, the advertisement including the arrival point based on the route information in a distribution area and including the expected arrival time at the arrival point in a target time slot of an advertising content or in a time slot preliminary time before a beginning of the target time slot.

A program according to one embodiment of the present disclosure causes a computer to execute operation. The operation includes: estimating an arrival point of a mobile object on a scheduled travel route to a destination and an expected arrival time at the arrival point; searching for an advertisement including the arrival point in a distribution area and including the expected arrival time at a target time slot of an advertising content or in a time slot preliminary time before a beginning of the target time slot; and outputting the searched advertisement.

An information processing method according to one embodiment of the present disclosure is an information processing method performed by a computer. The computer receives route information that is used to acquire an arrival point of a mobile object on a scheduled travel route to a destination and an expected arrival time at the arrival point. The computer transmits an advertisement to the terminal device, the advertisement including the arrival point based on the route information in a distribution area and including the expected arrival time at the arrival point in a target time slot of an advertising content or in a time slot preliminary time before a beginning of the target time slot.

The information processing device, the information processing system, the program, and the information processing method according to one embodiment of the present disclosure provide an advertisement useful for a user in a mobile object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an overall configuration of an information processing system including an information processing device according to a first embodiment of the present disclosure;

FIG. 2 is a first flowchart of an advertisement transmission process executed by a control unit of the information processing device of FIG. 1 in the first embodiment;

FIG. 3 is a second flowchart of the advertisement transmission process executed by the control unit of the information processing device of FIG. 1 in the first embodiment;

FIG. 4 is a first flowchart of an advertisement output process executed by the control unit of a terminal device of FIG. 1 in a second embodiment; and

FIG. 5 is a second flowchart of the advertisement output process executed by the control unit of the terminal device of FIG. 1 in the second embodiment.

### DETAILED DESCRIPTION OF EMBODIMENTS

Embodiments of the present disclosure will be described hereinbelow with reference to the drawings.

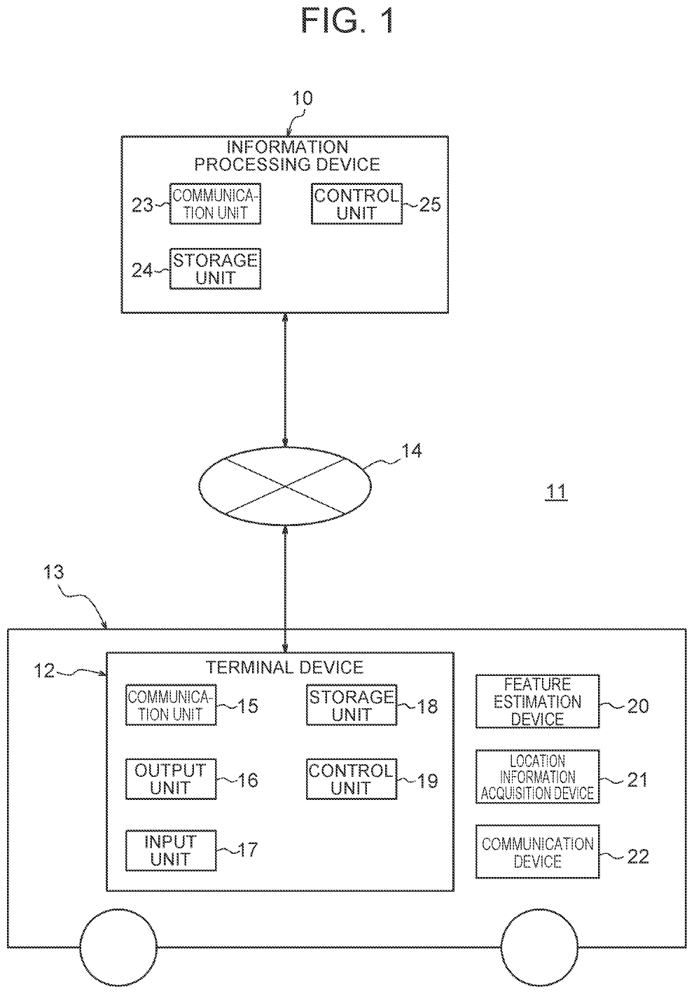

With reference to FIG. 1, the outline of an information processing system 11 including an information processing device 10 according to a first embodiment of the present disclosure will be described. The information processing system 11 includes a terminal device 12 and an information processing device 10.

For example, the terminal device 12 is a dedicated electronic device, such as a car navigation device, mounted and used in a mobile object 13, such as a vehicle, which travels on roads. However, without being limited thereto, the terminal device 12 may be a general-purpose electronic device, such as a portable terminal device including smartphones. The information processing device 10 includes one or more server devices communicable with each other. Although only one terminal device 12 is illustrated for convenience of description in FIG. 1, the information processing system 11 may include one or more terminal devices 12.

The first embodiment is outlined such that the terminal device 12 generates information that can be used to estimate an arrival point or the like of a mobile object 13 that uses the terminal device 12 on a travel route to a destination, and transmits the generated information to the information processing device 10 as route information. When receiving the route information, the information processing device 10 extracts an advertisement including the arrival point based on the route information in a distribution area and including the expected arrival time at the arrival point in a target time slot of an advertising content or in a time slot preliminary time before the beginning of the target time slot. The information processing device 10 transmits the extracted advertisement to the terminal device 12. The terminal device 12 notifies the received advertisement to an occupant or occupants by outputting the advertisement in the mobile object 13.

Next, respective component members of the information processing system 11 will be described in detail.

The terminal device 12 includes a communication unit 15, an output unit 16, an input unit 17, a storage unit 18, and a control unit 19.

The communication unit 15 includes a communication module that communicates through an in-vehicle network or an exclusive line, such as a controller area network (CAN) of the mobile object 13. The communication unit 15 may also include a communication module in conformity with short-distance radio communication standards, such as Bluetooth (registered trademark), for example. The communication unit 15 may include a communication module that connects to the network 14. For example, the communication unit 15 may include communication modules in conformity with mobile object communication standards such as 4th generation (4G) and 5th generation (5G).

In the first embodiment, the terminal device 12 is connected to devices mounted on the mobile object 13, such as a feature estimation device 20 and a location information acquisition device 21 through the communication unit 15, and performs information communication.

For example, the feature estimation device 20 includes a camera that images occupants in the mobile object 13 and a control unit. Based on an image imaged with the camera, the feature estimation device 20 estimates features of the occupants in the image, such as sex and age of the occupants. The feature estimation device 20 may identify the features of the occupants, such as clothes of the occupants in the image. The feature estimation device 20 may identify the features of the occupants as well as the locations of the respective occupants in the mobile object 13. The feature estimation device 20 transmits as information, the features of the occupants and further the locations of the occupants to the terminal device 12. The feature estimation device 20 may be incorporated in the terminal device 12.

The location information acquisition device 21 includes one or more receivers corresponding to any global positioning system. For example, the location information acquisition device 21 may also include a global positioning system (GPS) receiver. The location information acquisition device 21 acquires measurements of the location of the terminal device 12 as information, and transmits the information to the terminal device 12. The location information acquisition device 21 periodically acquires and transmits the measurements. The location information acquisition device 21 may be incorporated in the terminal device 12.

The terminal device 12 is connected to the network 14 through the communication unit 15, or through the communication unit 15 and the communication device 22 of the mobile object 13 so as to transmit and receive various information through the network 14. For example, the communication device 22 is a dedicated in-vehicle communication device. The communication device 22 may include a communication module in conformity with mobile object communication standards, such as 4th generation (4G) and 5th generation (5G) mobile object communication standards, in order to connect to the network 14.

The terminal device 12 may also be connected to terminal devices carried by the occupants in the mobile object 13 by short-distance radio communication through the communication unit 15 for communication of various information. For example, the terminal device 12 may receive, by short-distance radio communication, the features of occupants, such as sex, age, name, and occupation of the occupants as information from the terminal devices carried by the occupants.

When transmitting information through the network 14, the communication unit 15 may add identification information regarding the terminal device 12 to the information. The identification information regarding the terminal device 12 is information that enables the information processing system 11 to uniquely identify the respective terminal devices 12.

The output unit 16 includes one or more interfaces that output information and notify the information to the user. For example, the output unit 16 is a display that outputs information as a video image, or a speaker that outputs information by voice. However, the interface is not limited to these. The output unit 16 may have a plurality of displays, and the displays may be provided in different positions in the mobile object 13. For example, the displays may be provided at least in two positions in a vehicle, out of a position, such as a dashboard, suitable for visual recognition of occupants in front seats, a position, such as back surfaces of a driver's seat and a passenger's seat, suitable for visual recognition of the occupants right behind these seats, and a position, such as a ceiling in the vicinity of the backrests of the front seats, suitable for visual recognition of the occupants on rear seats. Alternatively, the terminal device 12 may transmit information to an external display device for outputting the information.

The input unit 17 includes one or more interfaces that detect a user input. The input unit 17 includes, for example, a physical key, an electrostatic capacity key, and a touchscreen integrally provided with the display of the output unit 16.

Although examples of the storage unit 18 include a semiconductor memory, a magnetic memory, or an optical memory, the storage unit 18 is not limited to these. The storage unit 18 may function as a main storage, an auxiliary storage, or a cache memory, for example. The storage unit 18 stores any information that is used for operation of the terminal device 12. For example, the storage unit 18 may store information such as system programs and application programs. The information stored in the storage unit 18 may be updated with the information that is received from the network 14 through the communication unit 15, for example.

The control unit 19 includes one or more processors. In the first embodiment, the “processor” is a general-purpose processor or an exclusive processor dedicated for specific processing. However, the “processor” is not limited to these. The dedicated processor may include an application-specific integrated circuit (ASIC). The control unit 19 may include a programmable logic device (PLD). The PLD may include a field-programmable gate array (FPGA). The control unit 19 controls operation of the entire terminal device 12.

When the input unit 17 detects that a destination of the mobile object 13 is input by a user, the control unit 19 stores the destination in the storage unit 18 as information. The control unit 19 stores the location of the terminal device 12 received from the location information acquisition device 21 in the storage unit 18 as information.

Even when the destination input by the user is not detected, the control unit 19 may estimate the destination based on a history of the locations of the terminal device 12 after the terminal device 12 moves for a prescribed distance from the startup of the terminal device 12, in other words, based on a route that is already passed. The control unit 19 estimates the destination by comparing, for example, the passed route with a past travel route stored in the storage unit 18. The control unit 19 stores the estimated destination in the storage unit 18 as information.

The control unit 19 may prepare a scheduled travel route recommendable to the mobile object 13, together with scheduled moving time and expected arrival time at the destination, based on the destination and the location of the terminal device 12 that is lastly received. The control unit 19 may further prepare expected arrival time at an optional point on the scheduled travel route. The control unit 19 stores in the storage unit 18 the scheduled travel route, the scheduled moving time, and the expected arrival time at the destination and at the optional point as information. The control unit 19 may control the output unit 16 to output the prepared scheduled travel route.

The control unit 19 prepares route information including a latest destination stored in the storage unit 18, route information including a latest destination, a scheduled travel route, scheduled moving time, and expected arrival time at the destination and at an optional point, or route information including a route that the terminal device 12 has passed after the startup of the terminal device 12 and a past travel route.

The route information is the information that enables the information processing device 10 to acquire an arrival point on the scheduled travel route to the destination and expected arrival time at the arrival point. The control unit 19 controls the communication unit 15 to transmit the route information to the information processing device 10. The arrival point includes the destination. When the scheduled travel route includes a highway, the arrival point includes the location of a dedicated rest facility for the highway within the range of the scheduled travel route. The arrival point includes a passing point on the scheduled travel route, when the destination is a home place of at least one of the mobile object 13 and an occupant of the mobile object 13. Examples of the home place include the home of an occupant, the location of an organization where an occupant belongs, and a contracted parking lot of the mobile object 13.

Alternatively, the control unit 19 may control the communication unit 15 to transmit to the information processing device 10 a route preparing request including route information, the route information including a destination stored in the storage unit 18 and the location of the terminal device 12 that is lastly received. Based on the request, the control unit 19 may control the output unit 16 to output the scheduled travel route received from the information processing device 10.

The control unit 19 may determine whether or not the destination is a home place, when the location of the home place is stored in the storage unit 18 in advance. When the destination is the home place, the control unit 19 controls the communication unit 15 to further transmit to the information processing device 10 the information indicating that the destination is the home place. The control unit 19 may control the communication unit 15 to transmit to the information processing device 10 the address of the home place, instead of the information indicating that the destination is the home place, as the information.

The control unit 19 controls the feature estimation device 20 to estimate the feature of an occupant. For example, the control unit 19 controls the feature estimation device 20 to estimate the feature of an occupant periodically, regularly, or after the startup of the terminal device 12. The control unit 19 receives as the information the estimated feature of an occupant, together with the location of the occupant in the mobile object 13. The control unit 19 acquires the received information as the feature of an occupant, and stores the information in the storage unit 18.

When the control unit 19 can perform short-distance radio communication with the terminal device carried by an occupant, the control unit 19 requests transmission of the information regarding the feature of the occupant from the terminal device through the communication unit 15. When the control unit 19 receives the feature of the occupant as information in response to the request, the control unit 19 stores the information in the storage unit 18.

The control unit 19 generates occupant composition information including at least the feature of the occupant stored in the storage unit 18 after the startup of the terminal device 12. The occupant composition information is information regarding the composition of an occupant or occupants of the mobile object 13. The occupant composition information includes at least the information that can be used to classify the composition of the occupants of the mobile object 13 into any one of a plurality of composition divisions. The occupant composition may be the composition of a single occupant, or may be the composition of a plurality of occupants. The composition divisions may include a division for a single occupant, and a division for a plurality of occupants.

The composition divisions may have a single layer, or may have a plurality of layers. The composition divisions of a single layer may be for rough classification into divisions such as family, friend, couple, and coworker. The composition divisions of a plurality of layers may include a first composition division for rough classification as in the composition divisions of a single layer, and a second composition division for more detailed classification. For example, the second composition divisions may be for classifying the above-stated family, which is one of the first composition divisions, into more detailed divisions, such as a division of parent and child, a division of grandparent and child, a division of grandparent, parent, and child, a division of father and son, a division of mother and daughter, and a division of brothers.

Alternatively, the control unit 19 may classify the composition of occupants into any one of the composition divisions based on the information indicating the features of the occupants stored in the storage unit 18, and may generate the classified composition divisions as occupant composition information.

For example, when the occupants consist of an adult male, an adult female, and a child or a small child, the control unit 19 classifies the composition of the occupants into a family composition division and a composition division of parent and child. For example, when the occupants consist of an adult male and a boy, the control unit 19 classifies the composition of the occupants into the family composition division and also a composition division of father and son. For example, when the occupants consist of a plurality of adults, the control unit 19 classifies the composition of the occupants into a friend composition division. For example, when the occupants consist of an adult male and an adult female, the control unit 19 classifies the composition of the occupants into a couple composition division.

The control unit 19 may add the clothes of the occupant to the composition divisions. Examples of the clothes include casual wear, sportswear, semi-formal dress or formal dress, and work clothes.

The control unit 19 controls the communication unit 15 to transmit occupant composition information including the information regarding the features of the occupants, or the occupant composition information indicating the composition divisions to the information processing device 10. When the output unit 16 includes a plurality of displays, the control unit 19 may control the communication unit 15 to transmit, together with the occupant composition information, information indicating the locations of the occupants in the mobile object 13 and the locations of the displays to the information processing device 10.

When receiving an advertisement as information from the information processing device 10 after transmission of the occupant composition information, the control unit 19 controls the output unit 16 to output the advertisement.

The information processing device 10 includes a communication unit 23, a storage unit 24, and a control unit 25.

The communication unit 23 includes a communication module that connects to the network 14. For example, the communication unit 23 includes communication modules in conformity with mobile object communication standards such as 4th generation (4G) and 5th generation (5G). In the first embodiment, the information processing device 10 is connected to the network 14 through the communication unit 23 to perform information communication with, for example, the terminal device 12. When transmitting information through the network 14, the communication unit 23 may add identification information regarding the information processing device 10 to the information. The identification information regarding the information processing device 10 is information that enables the information processing system 11 to uniquely identify the respective information processing devices 10.

The specific configuration and function of the storage unit 24 are the same as those of the storage unit 18 of the terminal device 12. For example, the storage unit 24 stores any information that is used for operation of the information processing device 10. The storage unit 24 stores as information an advertisement distributed in the network 14 in association with a distribution area and a target time slot. For example, the distribution area is a locational range where distribution of the advertisement is desired, the locational range being set by an advertiser. The target time slot is a time slot when the advertising content is effective, such as a bargain sale time of a specific product, and execution time of a specific event.

The advertisement is distributed through the network 14 from various server devices. The information processing device 10 may receive the advertisement, which is searched for by the information processing device 10, from various server devices. Examples of the advertisement include an advertisement of products and events in facilities such as shops.

The storage unit 24 may store the advertisement as information in association with the composition divisions. The advertisement may be associated with a single composition division or a plurality of composition divisions.

Examples of the composition division to be associated with an advertisement include a group that is set by manual input by an advertiser or by machine learning as a target to be notified. For example, the composition division to be associated with the advertisement is a family when desirable main targets of the advertisement are families, as in the case of services provided in facilities, such as family restaurants and house exhibition halls. For example, the composition division to be associated with the advertisement is a couple when desirable main targets of the advertisement are couples, as in the case of products and services provided in facilities, such as cafes, jewelry shops, and movie theaters showing romantic movies. For example, the composition division to be associated with the advertisement is a friend when desirable main targets of the advertisement are friends, as in the case of services provided in facilities, such as family restaurants and classrooms for giving lectures relating to hobbies. Examples of the composition division to be associated with the advertisement is a coworker when desirable main targets of the advertisement are office workers, as in the case of services provided in facilities, such as restaurants.

The storage unit 24 may store as information the advertisement in association with a combination of the composition divisions and the clothes of the occupants. For example, the combination is set by manual input by an advertiser or by machine learning. For example, the combination may be a family in semi-formal dress or formal dress or a couple in semi-formal dress or formal dress when the advertisement is about services provided in high-class restaurants. For example, the combination may be a family in casual wear, friends in casual wear, and the like, when the advertisement is about services provided in public restaurants. For example, the combination may be a family partially in sportswear, friends in sportswear, and the like, when the advertisement is about products provided in sporting goods stores. For example, the combination may be coworkers in work clothes and the like, when the advertisement is about provision of public bathhouses and massage services.

The storage unit 24 may store as information an advertisement in association with a target advertisement customer segment. For example, the target advertisement customer segment in association with an advertisement is set by manual input by an advertiser or by machine learning. Examples of the target advertisement customer segment in association with the advertisement include small child, schoolchild, junior high school student, high school student, college student, adult of 20 to 30 years old, adult of 40 to 50 years old, adult of 60 years old or older, male, and female.

The specific configuration of the control unit 25 is the same as that of the control unit 19 of the terminal device 12. The control unit 25 controls operation of the entire operation of the information processing device 10.

When receiving route information from the terminal device 12, the control unit 25 stores the route information in the storage unit 24. Based on the received route information, the control unit 25 acquires an arrival point of the mobile object 13 on the scheduled travel route to the destination, and expected arrival time at the arrival point.

For example, when receiving route information including a destination, the control unit 25 acquires the destination based on the route information. Alternatively, when, for example, receiving route information including a route that the terminal device 12 has already passed after the startup of the terminal device 12 and a past travel route, the control unit 25 acquires a destination by estimating the destination based on the passed route and the past travel route. The control unit 25 acquires the acquired destination as the arrival point for extraction of an advertisement.

Upon reception of the destination, the control unit 25 determines whether or not the scheduled travel route includes a highway. For the determination, the control unit 25 may acquire the scheduled travel route based on the route information. For example, when the route information includes a scheduled travel route, the control unit 25 acquires the scheduled travel route based on the route information. Alternatively, when, for example, receiving the route information which does not include the scheduled travel route, the control unit 25 may acquire the scheduled travel route by estimation based on the destination acquired as described above and the latest location of the mobile object 13.

When the scheduled travel route includes a highway, the control unit 25 acquires the location of a dedicated rest facility for the highway within the range of the scheduled travel route as an arrival point for extraction of an advertisement. For example, the dedicated rest facility for the highway is a service area or a parking area, in Japan.

The control unit 25 determines whether or not the destination is at least a home place of one of the mobile object 13 and an occupant. For example, when receiving information indicating that the destination is the home place, the control unit 25 may make the determination based on the information. Alternatively, when receiving the address of a home place as information, the control unit 25 may make the determination by comparing the destination set as described above and the address of the home place based on the received information. When the destination is the home place, the control unit 25 acquires an optional passing point on the travel route as an arrival point.

For example, when receiving route information including expected arrival time at a destination and an optional point, the control unit 25 acquires the expected arrival time at the destination and the passing point as arrival points based on the route information. For example, when receiving the route information which does not include expected arrival time, the control unit 25 estimates a scheduled travel route based on the destination acquired as described above and the latest location of the mobile object 13, and acquires the expected arrival time at the destination and the passing point as arrival points based on the scheduled travel route. When the optional point is distant beyond a threshold from the location of the rest facility dedicated for the highway, the control unit 25 acquires the expected arrival time at the location based on the estimated scheduled travel route.

The control unit 25 extracts from the storage unit 24 advertisements including the acquired arrival point in their distribution areas. The control unit 25 further extracts, out of the extracted advertisements, an advertisement including the expected arrival time at the acquired arrival point in a target time slot or in a time slot preliminary time before the beginning of the target time slot.

The preliminary time is time considered to be necessary for satisfactorily obtaining a product or service to be advertised after arriving at the destination of the mobile object 13. For example, the preliminary time is waiting time for entering a top group of a queue when the queue is expected to be formed in relation to the advertisement concerned. For example, the preliminary time is time considered to be necessary for getting a desired seat or getting to a front row, in the case where the advertisement is a viewing event such as an entertainment show. The preliminary time is also short break time desired before obtaining an advertised product or service after arriving at the destination of the mobile object 13. The preliminary time may also include moving time from the destination to a point of obtaining the advertised product.

The preliminary time may be changed in accordance with the content and type of an advertisement. The preliminary time may be changed in accordance with a distance from the destination to the point of obtaining the product or the like. The preliminary time may be set fixedly or variably through user input by an administrator of the information processing device 10. Alternatively, the preliminary time may be set by machine learning of values defined by the user input.

When receiving occupant composition information from the terminal device 12, the control unit 25 stores the occupant composition information in the storage unit 24. The control unit 25 acquires the composition division where the composition of the occupant or occupants of the mobile object 13 belong based on the received occupant composition information. For example, when receiving occupant composition information including information regarding the feature of an occupant and information on an attribute of the occupant, the control unit 25 classifies the composition of the occupant in the mobile object 13 into one of the composition divisions based on the occupant composition information, and thereby acquires the composition division of the occupant. Alternatively, when, for example, receiving the classified composition division as occupant composition information, the control unit 25 acquires the composition division through the acquisition of the occupant composition information. The control unit 25 further extracts, out of the advertisements extracted as described above, an advertisement associated with the acquired composition division.

When receiving information indicating the locations of the occupants and the locations of the displays, together with the occupant composition information, the control unit 25 stores the information in the storage unit 24. The control unit 25 estimates the occupants who recognize the information output from the respective displays, based on the locations of the occupants and the locations of the displays. For example, the control unit 25 may estimate an occupant who is closest to the location of a certain display as an occupant who recognizes the information output from the display. The control unit 25 may further extract, out of the advertisements associated with the composition division, advertisements to be output from the respective displays, based on the features of the occupants who recognize the information on the displays. For example, when the composition division is a family, and the occupant who recognizes the information on a certain display is a child, an advertisement that interests children is further extracted, out of the advertisements for family, as an advertisement displayed on the certain display.

The control unit 25 controls the communication unit 23 to transmit the extracted advertisement as information to the terminal device 12 which has transmitted the occupant composition information. When the scheduled moving time to the destination is equal to or less than a threshold, the control unit 25 may stop transmission of the advertisement. The control unit 25 may determine scheduled moving time based on the scheduled moving time included in setting information or the destination determined as described before. For example, transmission may be stopped based on stop of operation of advertisement extraction, or may be stopped based on the stop of operation of transmitting the extracted advertisement. For example, the threshold is set to be the time of moving a short distance, since distribution of advertisement during the time may annoy the occupant.

When receiving a route preparing request from an optional terminal device 12, the control unit 25 prepares a scheduled travel route recommended to the mobile object 13, together with scheduled moving time. The control unit 25 transmits the prepared scheduled travel route and scheduled moving time to the terminal device 12 as information.

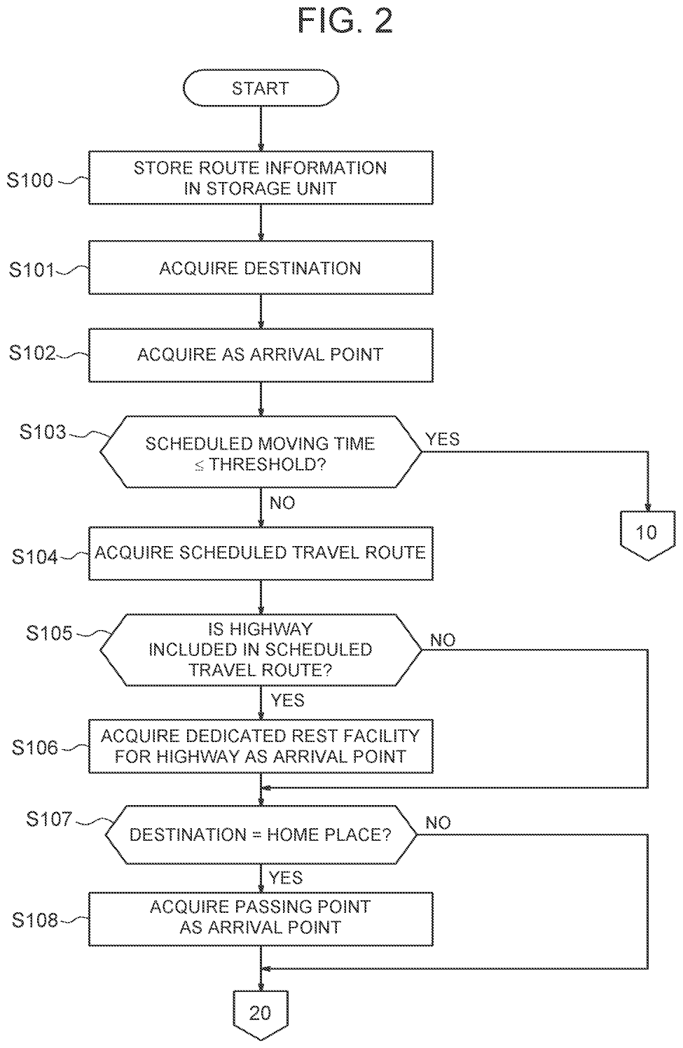

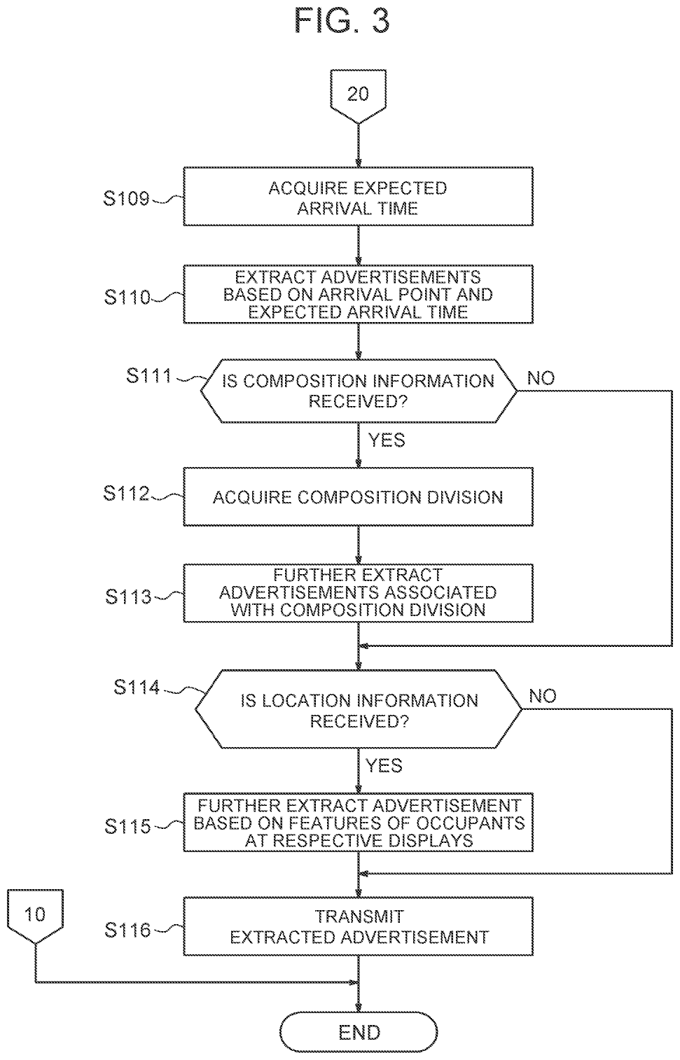

Next, an advertisement transmission process executed by the control unit 25 of the information processing device 10 in the first embodiment will be described with reference to the flowcharts of FIGS. 2 and 3. The control unit 25 starts the advertisement transmission process upon reception of route information from any terminal device 12.

In step S100, the control unit 25 stores route information in the storage unit 24. After the route information is stored, the process proceeds to step S101.

In step S101, the control unit 25 acquires a destination of the mobile object 13 based on the route information stored in step S100. After the destination is acquired, the process proceeds to step S102.

In step S102, the control unit 25 acquires the destination acquired in step S101 as an arrival point for extracting an advertisement. After the advertisement is acquired, the process proceeds to step S103.

In step S103, the control unit 25 determines whether or not scheduled moving time to the destination acquired in step S101 is equal to or less than a threshold. When the scheduled moving time is not equal to or less than the threshold, the process proceeds to step S104. When the scheduled moving time is equal to or less than the threshold, the control unit 25 ends the advertisement transmission process.

In step S104, the control unit 25 acquires a scheduled travel route to the destination based on the route information stored in step S100 and the destination acquired in step S101. After the scheduled travel route is acquired, the process proceeds to step S105.

In step S105, the control unit 25 determines whether or not a highway is included in the scheduled travel route acquired in step S104. When a highway is included, the process proceeds to step S106. When a highway is not included, the process proceeds to step S107.

In step S106, the control unit 25 acquires the location of a dedicated rest facility for the highway confirmed to be included in the scheduled travel route in step S105 as an arrival point for extracting the advertisement. After the location is acquired, the process proceeds to step S107.

In step S107, the control unit 25 determines whether or not the destination acquired in step S101 is a home place based on information indicating that the destination is the home place, or information indicating the address of the home place. When the destination is the home place, the process proceeds to step S108. When the destination is not the home place, the process proceeds to step S109.

In step S108, the control unit 25 acquires an optional passing point on the scheduled travel route acquired in step S104 as an arrival point for extracting the advertisement. After the optional passing point is acquired, the process proceeds to step S109.

In step S109, the control unit 25 acquires expected arrival time at the arrival point based on the route information stored in the storage unit 24 in step S100 and the arrival points acquired in steps S102, S106, S108. After acquisition, the process proceeds to step S110.

In step S110, the control unit 25 extracts the advertisements, which include the arrival points acquired in steps S102, S106, S108 in the distribution area, from the storage unit 24. The control unit 25 further extracts the advertisements which include the expected arrival time acquired in step S110 in the target time slots or in time slots preliminary time before the beginning of the target time slots. After extraction, the process proceeds to step S111.

In step S111, the control unit 25 determines whether or not occupant composition information is received. When the occupant composition information is received, the process proceeds to step S112. When the occupant composition information is not received, the process proceeds to step S114.

In step S112, the control unit 25 acquires a composition division where the composition of the occupant or occupants of the mobile object 13 that uses the terminal device 12 belong, based on the occupant composition information confirmed to be received in step S111. After the composition division is acquired, the process proceeds to step S113.

In step S113, the control unit 25 further extracts, out of the advertisements extracted in step S110, an advertisement or advertisements associated with the composition division acquired in step S112. After extraction, the process proceeds to step S114.

In step S114, the control unit 25 determines whether or not the information indicating the locations of the occupants and the location of a plurality of displays is received together with the occupant composition information. When the information is received, the process proceeds to step S115. When the information is not received, the process proceeds to step S116.

In step S115, the control unit 25 further extracts an advertisement or advertisements for the respective displays, out of the advertisements extracted in step S110 or S115, based on the features of the occupants who acquire the information on the respective displays. After extraction, the process proceeds to step S116.

In step S116, the control unit 25 controls the communication unit 23 to transmit the advertisement or advertisements extracted in steps S110, S112 or S114 to the terminal device 12. After transmission, the control unit 25 ends the advertisement transmission process.

When receiving the route information from the terminal device 12, the above-configured information processing device 10 of the first embodiment transmits an advertisement to the terminal device 12, the advertisement including an arrival point based on the route information in a distribution area and including expected arrival time at the arrival point in a target time slot of an advertising content or in a time slot preliminary time before the beginning of the target time slot. Among advertisements, there are time-specific advertisements for notifying that products or services will be provided or executed in a limited target time slot at special prices different from those in other time slots. While such a time-specific advertisement can be useful for users staying in the vicinity of the advertised facility in the target time slot, it is less likely that the advertisement interests other users. Under such circumstances, the information processing device 10 having the aforementioned configuration can notify the time-specific advertisement to the users who are expected to stay in the vicinity of the advertised facility in the target time slot. Therefore, the information processing device 10 can enhance the advertisement effects of the time-specific advertisements. As a result, the information processing device 10 can provide useful advertisements to the users in the mobile object 13.

In the information processing device 10 of the first embodiment, the arrival point includes a destination. In the information processing device 10 of the first embodiment, the arrival point includes the location of a dedicated rest facility for a highway within the range of the scheduled travel route. In the information processing device 10 of the first embodiment, when the destination is a home place of at least one of the mobile object 13 and an occupant, the arrival point includes a passing point on the scheduled travel route. With such configuration, the information processing device 10 can transmit an advertisement by defining, as the arrival point, a point where an occupant who rides in the mobile object 13 is highly likely to stay rather than simply pass through. Therefore, the information processing device 10 can further enhance the advertisement effects of the time-specific advertisements. As a result, the information processing device 10 can provide users with still more useful advertisements.

When receiving the occupant composition information from the terminal device 12, the information processing device 10 of the first embodiment transmits a time-specific advertisement, associated with a composition division where the composition of the occupant of the mobile object 13 belongs based on the occupant composition information, to the terminal device 12. In the mobile object 13, the type of the advertisement which interests the occupant is generally considered to vary depending on the composition of the occupant at the time. Under these circumstances, the information processing device 10 with the above configuration distributes the advertisement that can interest the occupant of the mobile object 13, i.e., the user.

In the information processing device 10 of the first embodiment, the route information includes a route that is already passed after the mobile object 13 starts to move. The arrival point and the expected arrival time of the mobile object 13 are acquired based on the passed route. With such configuration, the information processing device 10 can automatically acquire the arrival point without the user inputting the destination or the like, and therefore enhanced convenience can be achieved.

In the information processing device 10 of the first embodiment, the route information includes a destination, and the expected arrival time is acquired based on the destination. With such configuration, the information processing device 10 does not need calculation of the expected arrival time in the terminal device 12. Therefore, the information processing device 10 can reduce the load of the terminal device 12.

Description is now given of the outline of the information processing system 11 including the terminal device 12 that executes a program according to a second embodiment of the present disclosure. The second embodiment is different from the first embodiment in the point that the terminal device 12 executes the operation corresponding to extraction of an advertisement executed by the information processing device 10 in the first embodiment. Hereinafter, the second embodiment will be described by highlighting the difference from the first embodiment. The component members similar in configuration to those in the first embodiments are designated by similar reference numerals for description.

In the second embodiment, the information processing system 11 includes the terminal device 12 and the information processing device 10 as in the first embodiment. The second embodiment is outlined such that the terminal device 12 estimates an arrival point of the mobile object 13 on a scheduled travel route to a destination that uses the terminal device 12. The terminal device 12 estimates an expected arrival time at the arrival point. The terminal device 12 searches for an advertisement including the arrival point in a distribution area and including the expected arrival time in a target time slot of an advertising content or in a time slot preliminary time before the beginning of the target time slot. The terminal device 12 notifies the advertisement to an occupant or occupants of the mobile object 13 by outputting the searched and acquired advertisement in the mobile object 13.

As in the first embodiment, the terminal device 12 includes a communication unit 15, an output unit 16, an input unit 17, a storage unit 18, and a control unit 19. The structure of the communication unit 15, the output unit 16, the input unit 17, the storage unit 18, and the control unit 19 is the same as that in the first embodiment.

Unlike the first embodiment, the control unit 19 estimates a scheduled travel route recommendable to the mobile object 13, scheduled moving time, and expected arrival time at the arrival point on the scheduled travel route, based on destination input by the user, or on a history of the locations of the terminal device 12 after the terminal device 12 moves for a prescribed distance from the startup of the terminal device 12. The control unit 19 searches for an advertisement including the arrival point such as the destination in the distribution area, and including the expected arrival time in a target time slot of an advertising content or in a time slot preliminary time before the beginning of the target time slot. When advertisements associated with a specific distribution area and target time slot are received and stored in advance in the storage unit 18, the control unit 19 may search for an advertisement in the storage unit 18. The control unit 19 may search for an advertisement out of the advertisements which can be distributed by two or more information processing devices 10 through the network 14, after the arrival point and the expected arrival time are estimated.

Unlike the first embodiment, the control unit 19 determines whether or not some part of the scheduled travel route based on the destination includes a highway. When a highway is included, the control unit 19 adds a dedicated rest facility for the highway within the range of the scheduled travel route as an arrival area, and searches for an advertisement.

Unlike the first embodiment, the control unit 19 determines whether or not the destination is at least a home place of one of the mobile object 13 and an occupant. When the destination is the home place, the control unit 19 adds the home place to the arrival area, and searches for an advertisement.

Unlike the first embodiment, the control unit 19 acquires the composition division where the composition of the occupant or occupants of the mobile object 13 belong, based on the features of the occupants stored in the storage unit 18 after the terminal device 12 is started up. The control unit 19 searches for an advertisement by adding a condition of being associated with the acquired composition division to search conditions.

Unlike the first embodiment, when the output unit 16 has a plurality of displays, the control unit 19 reads the locations of the respective displays from the storage unit 18, and receives the locations of the occupants from the feature estimation device 20. The control unit 19 estimates the occupants who recognize the information output from the respective displays, based on the locations of the occupants and the locations of the displays. The control unit 19 adds the features of the occupants, who recognize the information on the displays, to search conditions, and searches for an advertisement for each of the displays.

Unlike the first embodiment, the control unit 19 controls the output unit 16 to output the searched advertisement. Unlike the first embodiment, when the output unit 16 has a plurality of displays, the control unit 19 controls the displays to output the advertisement searched for each of the displays. Unlike the first embodiment, the control unit 19 controls the displays to stop output of the advertisement, when the scheduled moving time is less than a threshold.

The information processing device 10 distributes a plurality of advertisements associated with various conditions, such as a distribution area and a target time slot, under the management of advertisers or agents which conduct advertisement business.

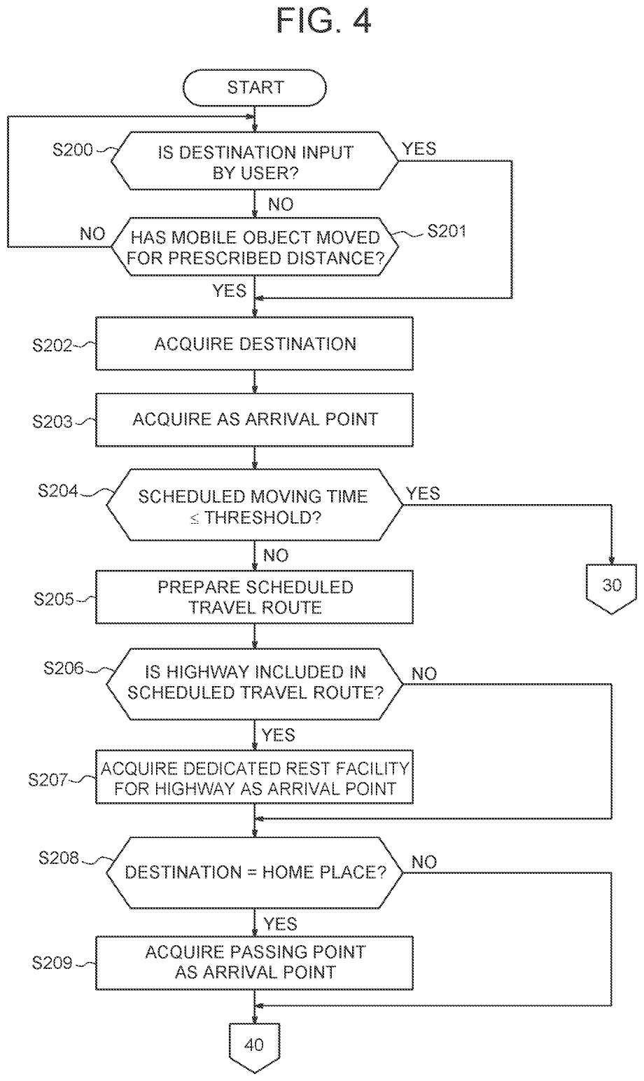

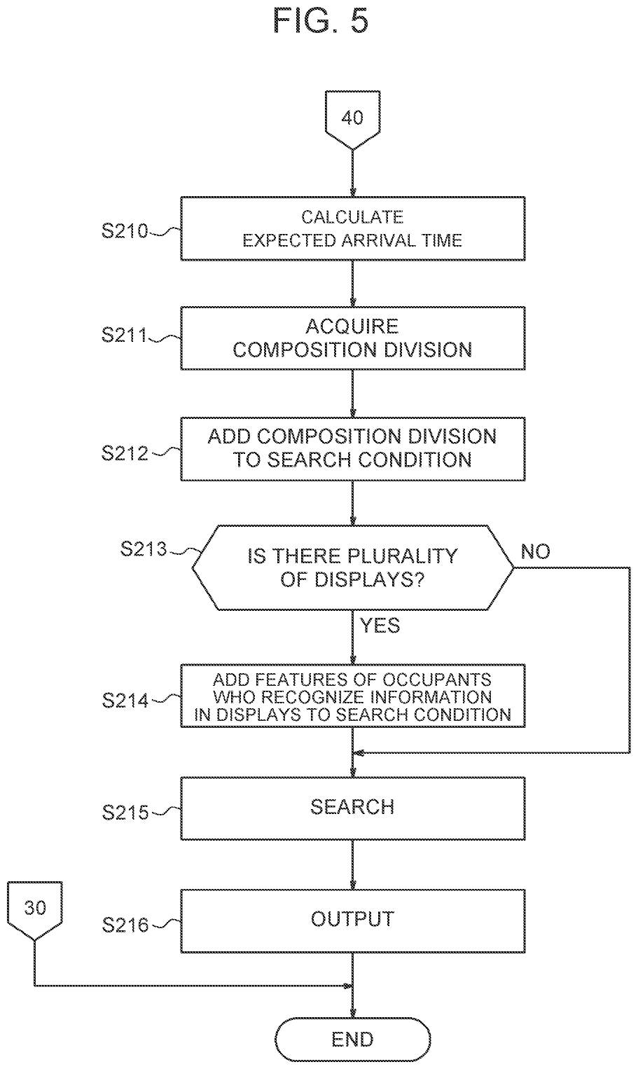

Next, an advertisement output process executed by the control unit 19 of the terminal device 12 in the second embodiment will be described with reference to the flowcharts of FIGS. 4 and 5. The advertisement output process is started at the startup of the terminal device 12.

In step S200, the control unit 19 determines whether or not the input unit 17 detects the destination of the mobile object 13 input by a user. When the information is detected, the process proceeds to step S202. When the information is not detected, the process proceeds to step S201.

In step S201, the control unit 19 determines whether or not the mobile object 13 has moved for a prescribed distance after the startup of the terminal device 12. When the mobile object 13 has moved, the process proceeds to step S202. When the mobile object 13 has not moved, the process returns to step S200.

In step S202, the control unit 19 acquires the destination that is input into the input unit 17 by the user or that is estimated based on the route that the mobile object 13 has passed. After the destination is acquired, the process proceeds to step S203.

In step S203, the control unit 19 acquires the destination acquired in step S202 as one of the arrival points used as an advertisement search condition. After the arrival point is acquired, the process proceeds to step S204.

In step S204, the control unit 19 determines whether or not scheduled moving time to the destination acquired in step S202 is equal to or less than a threshold. When the scheduled moving time is not equal to or less than the threshold, the process proceeds to step S205. When the scheduled moving time is equal to or less than the threshold, the control unit 19 ends the advertisement output process.

In step S205, the control unit 19 prepares a scheduled travel route to the destination acquired in step S202. After the scheduled travel route is prepared, the process proceeds to step S206.

In step S206, the control unit 19 determines whether or not a highway is included in the scheduled travel route prepared in step S205. When a highway is included, the process proceeds to step S207. When a highway is not included, the process proceeds to step S208.

In step S207, the control unit 19 acquires a dedicated rest facility for the highway within the range of the scheduled travel route as one of the arrival points used as an advertisement search condition. After the arrival point is acquired, the process proceeds to step S208.

In step S208, the control unit 19 determines whether or not the destination acquired in step S202 is a home place of at least one of the mobile object 13 and an occupant. When the destination is the home place, the process proceeds to step S209. When the destination is not the home place, the process proceeds to step S210.

In step S209, the control unit 19 acquires an optional passing point on the scheduled travel route prepared in step S205 as one of the arrival points used as an advertisement search condition. After the passing point is acquired, the process proceeds to step S210.

In step S210, the control unit 19 calculates expected arrival time at the arrival points acquired in steps S203, S207, S209. After calculation, the process proceeds to step S211.

In step S211, the control unit 19 acquires a composition division where the composition of the occupant or occupants of the mobile object 13 belongs, based on the information indicating the features of the occupants received from the feature estimation device 20. After the composition division is acquired, the process proceeds to step S212.

In step S212, the control unit 19 adds the composition division acquired in step S211 to the advertisement search condition. After the composition division is added, the process proceeds to step S213.

In step S213, the control unit 19 determines whether or not an advertisement can be output on a plurality of displays. When the advertisement can be output to the displays, the process proceeds to step S214. When the advertisement cannot be output to the displays, the process proceeds to step S215.

In step S214, the control unit 19 adds the features of the occupants, who recognize the information on the displays, to the advertisement search conditions. After the features are added, the process proceeds to step S215.

In step S215, the control unit 19 searches for an advertisement or advertisements that include the arrival points acquired in steps S203, S205, S207, S209 in the distribution range and include the expected arrival time acquired in step S210 in the target time slot or the time slot preliminary time before the beginning of the target time slot, and that satisfy the search conditions added in steps S212, S214. After the advertisement is searched, the process proceeds to step S216.

In step S216, the control unit 19 controls the output unit 16 to output the advertisement searched in step S215. After the advertisement is output, the control unit 19 ends the advertisement transmission process.

The above-configured terminal device 12 of the second embodiment can also provide the same effects as the first embodiment.

While the present disclosure has been described based on drawings and embodiments, it is to be understood that those skilled in the art can easily make various transformations and corrections based on the present disclosure. Therefore, it is to be noted that these transformations and corrections are intended to be embraced in the range of the present disclosure. For example, the functions, or the like, included in each configuration or each step can be rearranged without causing logical inconsistency, and a plurality of means or steps can be integrated into unity or can be divided.

For example, in the embodiments disclosed, some processing operations executed in the information processing device 10 and the terminal device 12 may be executed in other devices.

For example, the terminal device 12 executes the process of transmitting the route information to the information processing device 10 and the process of outputting the advertisement received from the information processing device 10. However, these operations may be executed by different terminal devices. For example, a terminal device for transmitting information may transmit the route information, and a terminal device for outputting advertisement may output the advertisement received from the information processing device 10. In such configuration, the information processing device 10 may receive the route information from the terminal device for transmitting information, and may transmit an advertisement to the terminal device for outputting advertisement. For example, the terminal device for outputting advertisement may be notified to the information processing device 10 by transmission of identification information regarding a terminal device registered in the terminal device for transmitting information and identification information regarding a terminal device communicating with the terminal device for transmitting information.

For example, although the information processing device 10 is configured to directly receive the route information from the terminal device 12, the information processing device 10 may be configured to indirectly receive the route information from the terminal device 12. In other words, the information processing device 10 may be configured to receive the route information through an external device other than the terminal device 12. Specifically, the information processing device 10 may receive, for example, the route information itself or partially processed route information from a server, or the like, which receives the route information from the terminal device 12. Alternatively, the information processing device 10 may receive the route information from a server, or the like, which independently generates the route information for the mobile object 13 that uses the terminal device 12, without involving transmission from the terminal device 12.

Moreover, general-purpose electronic devices, such as smartphones or computers, may be configured to function as the information processing device 10 and the terminal device 12 according to the embodiments. Specifically, programs describing the contents of processes that implement functions of the information processing device 10 and the terminal device 12 according to the embodiments are stored in the memory of the electronic devices, and the programs are read and executed by the processors of the electronic devices. Therefore, the disclosure according to the present embodiments may be implemented as programs executable by the processors. The programs may be downloaded through the network 14, or may be stored in non-transitory recording and storage media readable by electronic devices, and the electronic devices may read the programs from the media.

What is claimed is:

1. An information processing device, comprising:
a communication unit configured to perform information communication with a terminal device used in a mobile object; and
a control unit configured to control the communication unit, when receiving route information that is used to acquire an arrival point of the mobile object on a scheduled travel route to a destination and an expected arrival time at the arrival point, such that the communication unit transmits an advertisement to the terminal device, the advertisement including the arrival point based on the route information in a distribution area and including the expected arrival time at the arrival point in a target time slot of an advertising content or in a time slot preliminary time before a beginning of the target time slot.

2. The information processing device according to claim 1, wherein the arrival point includes the destination.

3. The information processing device according to claim 1, wherein the arrival point includes a location of a dedicated rest facility for a highway within a range of the scheduled travel route.

4. The information processing device according to claim 1, wherein the arrival point includes a passing point on the scheduled travel route, when the destination is a home place of at least one of the mobile object and an occupant.

5. The information processing device according to claim 1, wherein when receiving occupant composition information regarding composition of the occupant of the mobile object from the terminal device, the control unit is configured to control the communication unit so as to transmit the advertisement to the terminal device, the advertisement being associated with a composition division where the composition of the occupant of the mobile object belongs based on the occupant composition information.

6. The information processing device according to claim 1, wherein:
the route information includes a route that is already passed after the mobile object starts to move; and
the control unit acquires the arrival point and the expected arrival time of the mobile object based on the passed route.

7. The information processing device according to claim 1, wherein:
the route information includes the destination; and
the control unit acquires the expected arrival time based on the destination.

8. An information processing system, comprising:
an information processing device according to claim 1; and
the terminal device.

9. A program causing a computer to execute operation comprising:
estimating an arrival point of a mobile object on a scheduled travel route to a destination and an expected arrival time at the arrival point;
searching for an advertisement including the arrival point in a distribution area and including the expected arrival time in a target time slot of an advertising content or in a time slot preliminary time before a beginning of the target time slot; and
outputting the searched advertisement.

10. The program according to claim 9, wherein the arrival point includes the destination.

11. The program according to claim 9, wherein the arrival point includes a location of a dedicated rest facility for a highway within a range of the scheduled travel route.

12. The program according to claim 9, wherein the arrival point includes a passing point on the scheduled travel route, when the destination is a home place of at least one of the mobile object and an occupant.

13. The program according to claim 9, causing the computer to execute operation, further comprising searching for the advertisement when acquiring a feature of the occupant of the mobile object, the advertisement being associated with a composition division where a composition of the occupant of the mobile object belongs based on the feature.

14. The program according to claim 9, causing the computer to execute operation, further comprising estimating the arrival point and the expected arrival time based on a route that is already passed after the mobile object starts to move.

15. An information processing method performed by a computer, the method comprising:
the computer receiving route information that is used to acquire an arrival point of a mobile object on a scheduled travel route to a destination and an expected arrival time at the arrival point; and
the computer transmitting an advertisement to the terminal device, the advertisement including the arrival point based on the route information in a distribution area and including the expected arrival time at the arrival point in a target time slot of an advertising content or in a time slot preliminary time before a beginning of the target time slot.

16. The information processing method according to claim 15, wherein the arrival point includes the destination.

17. The information processing method according to claim 15, wherein the arrival point includes a location of a dedicated rest facility for a highway within a range of the scheduled travel route.

18. The information processing method according to claim 15, wherein the arrival point includes a passing point on the scheduled travel route, when the destination is a home place of at least one of the mobile object and an occupant.

19. The information processing method according to claim 15, wherein:
the computer receives occupant composition information regarding composition of the occupant of the mobile object from the terminal device; and
the computer transmits the advertisement to the terminal device, the advertisement being associated with a composition division where composition of the occupant of the mobile object belongs based on the occupant composition information.

20. The information processing method according to claim 15, wherein the computer acquires the arrival point and the expected arrival time of the mobile object based on a route that is already passed after the mobile object starts to move, the passed route being included in the route information.
